(19) United States
(12) Patent Application Publication
(10) Pub. No.: US 2021/0316624 A1
(43) Pub. Date: Oct. 14, 2021

(54) CHARGING DEVICE HAVING CONTROLLABLE DC LINK CENTER POINT VOLTAGE, AND DRIVE SYSTEM HAVING SUCH A CHARGING DEVICE

(71) Applicant: JHEECO E-DRIVE AG, Eschen (LI)

(72) Inventor: Katja STENGERT, Lienz (CH)

(21) Appl. No.: 17/269,780

(22) PCT Filed: Aug. 12, 2019
(86) PCT No.: PCT/EP2019/071529

§ 371 Date: Feb. 19, 2021

(30) Foreign Application Priority Data
Aug. 20, 2018 (DE) 10 2018 120 236.9

(51) Int. Cl. B60L 53/24; H02J 7/24; H02M 3/158; H02M 1/00; H02M 7/483; H02P 27/14

(52) U.S. Cl. CPC B60L 53/24; H02J 7/24; H02M 3/158; H02M 1/007; H02M 7/487; H02P 27/14; H02J 2207/20; H02P 2201/09; H02M 7/4833

(57) ABSTRACT

The invention relates to a charging device for charging a battery of a motor vehicle having an electric drive motor. The charging device has an inductor and a drive converter, which converts a direct voltage of the battery for the electric drive motor during drive operation of the motor vehicle and which has a DC link center point. The inductor, together with the drive converter, is used as a step-up converter for charging operation of the battery. The aim of the invention is to provide a compact and economical charging device This aim is achieved in that the charging device has a controllable switching device, which is designed to charge and/or discharge the DC link center point to a voltage.

### CROSS-REFERENCE TO RELATED APPLICATIONS

This application is a 371 of PCT Application No. PCT/EP2019/071529 filed on Aug. 12, 2019, which claims priority to German Application No. 10 2018 120 236.9 filed on Aug. 20, 2018, the contents of which are hereby incorporated by reference as if recited in their entirety.

### TECHNICAL FIELD

The invention refers to a charging device for charging a battery of a motor vehicle having an electric drive motor and an electric drive system having such a charging device.

### BACKGROUND

Different charging concepts are used for charging electric vehicles. Charging with alternating current via the household socket is available almost everywhere, but has only low charging capacities of less than 5 kW. In contrast, much higher power levels (50 kW and above) are possible with rapid charging at direct current sources (DC charging), for example via special charging stations. However, this requires an adjustment of the charging voltage if the available voltage level of the charging station, typically 400 V DC, is lower than the voltage level of the vehicle battery, in the medium term 800 V DC.

Step-up converters, also known as boost converters, can be used as separate units to adjust the voltage level. But it is also possible to use an already existing inverter of the traction motor or electric motor as a step-up converter for DC-conversion. In order not to use additional inductors in the inverter for the step-up conversion, it is known to use the windings of the traction motor as charging inductors:

DE 10 2016 209 905 A1 shows a rapid charging unit for an electric vehicle, wherein the inverter of the traction motor in combination with the motor coils serves as step-up converter.

DE 10 2009 052 680 A1 shows the upstream connection of a step-down converter in front of the inverter.

In addition to 2-level inverters, there are also 3-level inverters for electric vehicles, which have a third voltage level. Especially 3-level inverters with NPC topology (neutral point clamped) reduce the voltage applied to the switching elements of the half bridges to half of the nominal voltage. Accordingly, these are usually only adapted for this voltage.

DE 10 2016 218 304 B3 shows a 3-level inverter in NPC configuration (abbreviation for “neutral point clamped”) for an electric vehicle, which can be operated in rapid charging mode as a step-up converter, whereby external inductors are used as inductors for the step-up conversion.

When operating a 3-level inverter as step-up converter it must be avoided that the switching elements see the full nominal voltage. Due to topology, certain switching states are forbidden, so that certain switching elements must be switched in an offset manner—first an inner and then an outer switching element. During this time, a current flows into the center of the DC link (or its capacitor) and charges it undesirably and with each switching cycle. If the voltage of the DC link center exceeds the permissible reverse voltage of the switching elements or diodes, or if the voltage of the DC link center exceeds the permissible voltage of the capacitor, the affected element will fail and lead to a defect of the inverter. This must be avoided.

During normal operation (inversion DC−>AC) the voltage level oscillates in the DC link center; however, the DC link center does not charge. To reduce these oscillations, the DC link voltage is either not regulated at all or is actively regulated.

One possibility is the virtual regulation via an adapted control of the half bridges. The pulse widths of the individual phases are adjusted in time in such a way that the current effectively flowing into the DC link center is reduced. This means that the pulse widths of a phase are not all of the same length. An example for this is U.S. Pat. No. 5,790,396.

Another possibility is the equalization by feeding in external equalizing charges:

WO 2012/093504 A1 shows a 3-level inverter with active voltage balancing in inverter mode (conversion DC−>AC) with the aim of reducing the size of the capacitors contained in the DC link. The balancing device comprises controllable switches and at least one auxiliary capacitor which is constantly precharged by external means and provides a charge for voltage equalization. The balancing device is located directly between the center of the DC link and the neutral input of the half bridge; in particular, it has no connection to positive and negative busbars.

In order to charge an electric vehicle battery with existing DC charging stations, an adaptation element in the form of a DC/DC converter is required on the vehicle side. If a 3-level NPC inverter is now used as the switching topology, it is desired to use it as a DC/DC converter at the same time. At the same time, a solution is sought for the voltage balancing of the two DC link capacities C1 and C2, i.e. the maintenance and/or control of a DC link voltage or center point voltage.

### SUMMARY

It is thus the object of the present invention to provide an improved DC charging device for charging a battery of a motor vehicle equipped with an electric motor.

According to the invention, a charging device according to claim 1 is provided for this purpose. It is in particular a charging device for charging a battery of a motor vehicle equipped with an electric drive motor, having an inductor and a drive converter, which converts the DC voltage of the battery for the electric drive motor during the drive operation of the motor vehicle and has a DC link center, the inductor together with the drive converter serving as step-up converter for a charging operation of the battery. The charging device has a controllable switching device which is adapted to charge and/or discharge the DC link center electrically or to a voltage.

This prevents the DC link center voltage from rising above a permissible level during the charging process and a destruction of the capacitor and/or switching elements or diodes occurs. In order for the drive converter to act as a step-up converter, it should be controlled accordingly during charging operation, especially its switching units in the form of transistors, in order to step up the input voltage (that of the charging source) to a higher output voltage (that of the vehicle battery). The switching units are periodically opened and closed. According to the invention, the controllable switching device of the charging device serves the active voltage control, especially the active voltage balancing. Here, the DC link center is connected in such a way that it is electrically charged and/or discharged in order to achieve and maintain a certain voltage. Due to the term “voltage balancing” it can be assumed that the DC link center can be charged or maintained at half the voltage of the vehicle battery.

Preferably, voltage balancing is achieved by means of a switching device adapted in this way, which electrically connects or switches the DC link center with the positive pole and/or the negative pole of the vehicle battery, in particular periodically or alternately. This saves on an additional voltage source, thus reducing the costs of the charging device.

Preferably the switching device has at least two transistors which are connected to the positive and the negative pole of the battery and are in particular connected to the DC link center via a choke coil. This is a practical embodiment that does not require any mechanical switches. The choke coil has the advantage of blocking currents with high frequencies, thus enabling a more even flow of current for voltage control.

It has also proven to be advantageous if the inductor has at least one winding or winding section of the electric drive motor or is formed by at least this. In this way, additional components can be saved, thus reducing costs and space requirements.

With the aim of providing an efficient voltage conversion in charging mode in addition to the control of the electric motor for driving operation, the drive converter has a 3-level inverter (also phase leg) for three voltage phases, in particular in the form of one half bridge per phase. Each 3-level inverter is connected to one of the three windings of the electric drive motor. This also has the advantage that all three windings can each be used for a step-up converter, especially individually or simultaneously, thus increasing the charging power.

Preferably, the 3-level inverters or half bridges have the same DC link center. This allows the connection with only one line, which again saves components and materials.

In another advantageous embodiment, one of the three 3-level inverters or half bridges is the controllable switching device. Although this reduces the charging power, it also reduces the costs for the charging device. In this case, it may be provided that the switching device is disconnectable, especially via a switch, from a winding of the electric drive motor.

It is also advantageous if the DC link center is located between two capacitors connected in series, whereby the battery of the motor vehicle can be connected in parallel with the capacitors.

Preferably, the charging device has a control circuit for controlling the drive converter, in particular its half bridges, as step-up converter. Thus, the control circuit is able to act both as a drive converter and as a step-up converter, thus saving costs for additional components.

The active voltage control can be dependent on a voltage measuring device for measuring the voltage of the DC link center. The control circuit is adapted to control the switching device depending on the measured voltage, e.g. by means of a PI controller.

The present invention also provides for an electric drive system with a charging device according to the invention and a vehicle battery.

### BRIEF DESCRIPTION OF THE DRAWINGS

The present invention also provides for an electric drive system with a charging deice according to the invention and a vehicle battery.

The following drawings show preferred embodiments of the charging device according to the invention, whereby these are not considered as a limitation of the invention, but essentially serve as an illustration.

FIG. 1 shows a circuit diagram of an electric drive system with a charging device according to a first embodiment;

FIG. 2 shows signal diagrams of the currents of individual components of the charging device from FIG. 1;

FIG. 3 shows signal diagrams of currents and voltages with respect to the DC link center of a charging device according to the invention;

FIG. 4 shows signal diagrams of currents and voltages according to FIG. 3, which are displayed enlarged in time;

FIG. 5 shows a circuit diagram of an electric drive system with a charging device according to a second embodiment; and

FIG. 6 shows a circuit diagram of an electric drive system with a charging device according to a third embodiment

FIG. 7 shows a circuit diagram of an electric drive system with a charging device according to a fourth embodiment.

### DETAILED DESCRIPTION

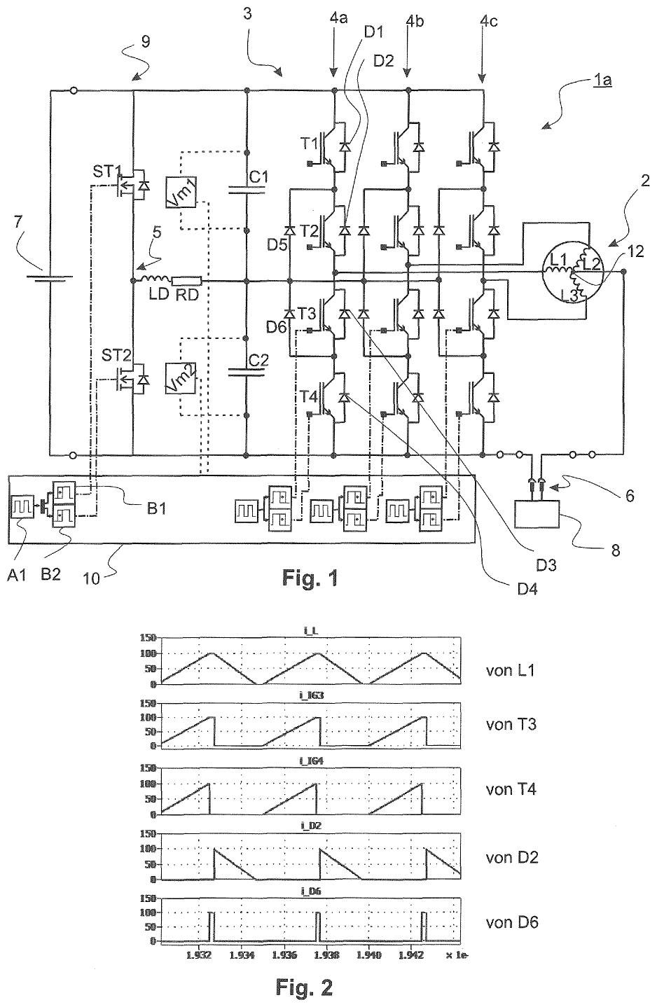

FIG. 1 shows an electric drive system 1a equipped with an electric motor 2. The electric motor 2 has three inductors L1, L2 and L3 in the form of coil windings. These coils L1, L2 and L3 are each supplied with an alternating current by means of a half bridge 4a, 4b and 4c of a drive converter 3 and are able to set the electric motor 2, in particular its rotor (not shown), in rotation. To convert the direct current from a battery 7 into alternating current, the half bridges 4a, 4b and 4c are controlled by a control circuit 10. The half bridges 4a, 4b and 4c are controlled in such a way that they periodically and alternately connect the positive pole and the negative pole with the coils L1, L2 and L3. The three generated alternating currents of the half bridges are shifted in phase to each other by 120°. Each half bridge 4a, 4b and 4c has the following components: four transistors (e.g. MOSFETs, especially IGBTs) T1, T2, T3 and T4, each with one diode D1, D2, D3 and D4 connected between drain and source, and two diodes D5 and D6 connected to a DC link center 5 of the drive inverter 3. The DC link center 5 is located between the two series-connected DC link capacitors C1 and C2, which are arranged parallel to the three half bridges 4a, 4b and 4c. The DC link center 5 is electrically connected to each half bridge 4a, 4b and 4c via the corresponding diodes D5 and D6. The three inductors L1, L2 and L3 of the electric motor 2 are interconnected in a star connection; in drive mode, a delta connection of the coils L1, L2 and L3 is also possible. Furthermore, a conductor extends from the star point 12 of the electric motor 2 to a plug connection 6, which connects a charging source 8, e.g. a charging station, with the negative pole of the battery 7 and the star point 12. During drive or travel mode, either the plug connection 6 is electrically separated from the rest of the system 1a, e.g. by a switch, or no charging source 8 is connected to connection 6. The vehicle battery 7 is connected to the drive inverter 3 and supplies it with a DC voltage. For the drive mode the control circuit 10 of the electrical drive system 1 is formed to control the half bridges 4a, 4b and 4c and thus their transistors D1, D2, D3 and D4 in such a way that an alternating current is generated in each case, which is shifted by 120° phases to the other two currents. Thus, for example, a current flows from the positive pole of battery 7, via the transistors T1 and T2 of the first half bridge 4a to the first coil L1 and then via the coils L2 and L3 and their transistors T3 and T4 of the second and third half bridges 4b and 4c to the negative pole of battery 7. For the charging mode, the control circuit 10 is adapted to control the half bridges 4a, 4b and 4c in such a way that they act as step-up converters in combination with the coils L1, L2 and L3.

During the charging mode, each time transistor T4 and then transistor T3 are blocked, a small equalizing current flows into the DC link center 5 and charges the capacitors C1 and C2. Normally the voltage of the center 5 is half of the battery voltage 7, especially during the drive mode. During charging mode, the voltage of the DC bus center 5 shifts due to the equalizing current and affects the efficiency and functionality of the step-up converter. A controllable switching device 9 is provided to neutralize this electrical charge. In this case the switching device 9 has two transistors ST1 and ST2, which are connected to the DC link center 5 via a choke coil LD and a decoupling resistor RD. The two transistors ST1 and ST2 are connected in series with each other and in parallel to battery 7 as well as to the two capacitors C1 and C2. The transistors ST1 and ST2 are controlled by the control circuit 10 in such a way that an electric charge is conducted either from the battery 7 to the DC link center 5 or vice versa. This allows the voltage of the center 5 to be increased or decreased to a certain value and finally maintained or stabilized. The voltage of the center 5 is determined by measuring the voltage of the two capacitors C1 and C2. For this purpose a first and a second voltmeter are connected in parallel to the capacitors C1 and C2 and pass the result of the voltage measurement to control circuit 10. The control circuit 10 has a square wave signal generator A1 and two signal modulators B1 and B2 both for the transistors ST1 and ST2 of the switching device 9 and for the transistors T3 and T4 of the half bridges 4a, 4b and 4c.

FIG. 2 shows five current diagrams for the following circuit elements (from top to bottom, X-axis: current in amperes, Y-axis: time in milliseconds) during the charging mode: coil L1, transistor T3, transistor T4, diode D2 and diode D6. The current flow through the coil L1 runs as a triangular shape from 0 to 100 amperes (see first diagram). In the second and third diagram the current flow is shown, which runs once through transistor T3 and once through transistor T4 (see second and third diagram). Here it can be seen that the current flow through transistor T4 stops earlier compared to transistor T3. This means that transistor T4 blocks before transistor T3. As soon as transistor T3 also blocks, the current flows from coil L1 via diode D2 (and diode DI) to battery 7 (see fourth diagram). In the short time in which transistor T4 is off and transistor T3 is still open, the small equalizing current flows via diode D6 to the DC link center 5 (see fifth diagram), thereby charging it.

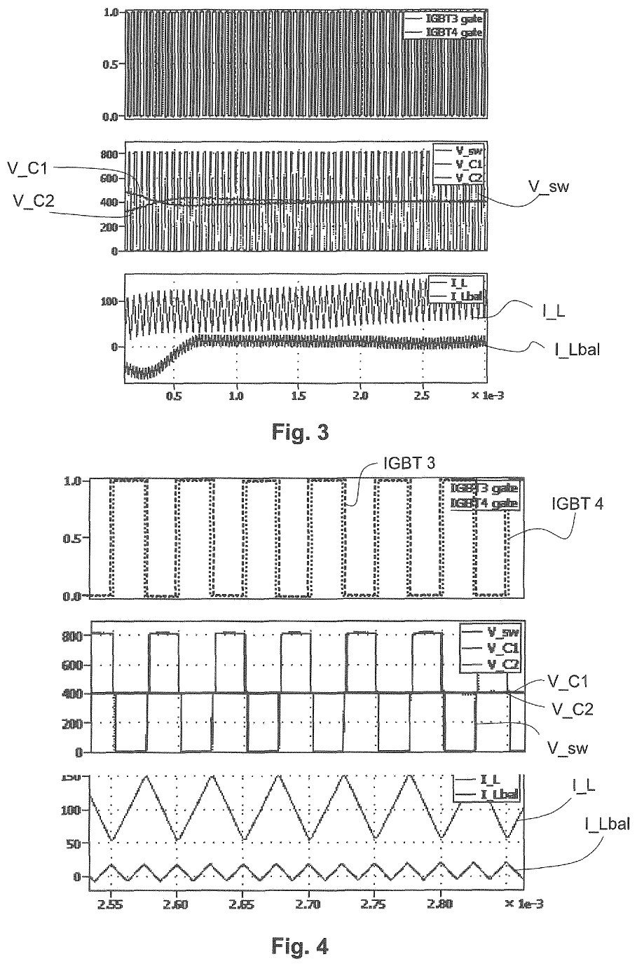

FIGS. 3 and 4 each show three signal diagrams of different circuit elements from the drive system of FIG. 1, with the signals in FIG. 3 ranging from 0 seconds to 3 milliseconds and in FIG. 4 from approximately 2.55 to 2.95 milliseconds. This means that the signals of the signal diagrams in FIG. 4 are enlarged to those in FIG. 3, but are ultimately identical. The first signal diagram shows the voltage signals IGBT3 and IGBT4 as gate control signals of transistors T3 and T4 (X-axis: 0 to 1 Volt). Here it can be clearly seen that transistor T4 always blocks before transistor T3, so that transistor T3 does not see the complete voltage and is thus protected. The second signal diagram shows the voltages V_C1 and V_C2 at the capacitors C1 and C2, which oscillate by half the battery voltage (X-axis: 0 to 800 Volt) due to the controlled switching device 9. Here it can be seen that the voltage of the DC link center 5, which corresponds to the voltage V_C2 or the voltage of the battery 7 minus the voltage V_C1, levels-off or stabilizes over time. The voltage V_SW shows the voltage that has been converted upwards to 800V by the step-up converter as soon as both transistors T3 and T4 are disabled or open and no more current flows through these transistors. When both transistors T3 and T4 are closed and current flows through them, the voltage drops to approximately 0V or to the voltage of the negative pole of battery 7 plus the voltage drop via transistors T3 and T4. In the short time in that the fourth transistor T4 is open and the third transistor T3 is closed, a current flows temporarily via diode D6 (see also 5^{th} diagram of FIG. 2) to the DC link center 5 (see FIG. 1). This current must be neutralized by means of the controllable switching device 9. The third signal diagram shows the current I_L coming from the coil and a current I_Lbal (X-axis: 0 to 150 amps) flowing through the choke coil, which is used to charge/discharge the DC link center 5 or the capacitors C1 and C2 and thus stabilize its voltage. The two currents stabilize over time and finally oscillate around an average value each, I_L at 100 A and I_Lbal at about 5 A. The frequency of the current I_L is lower than the frequency of the current I_Lbal.

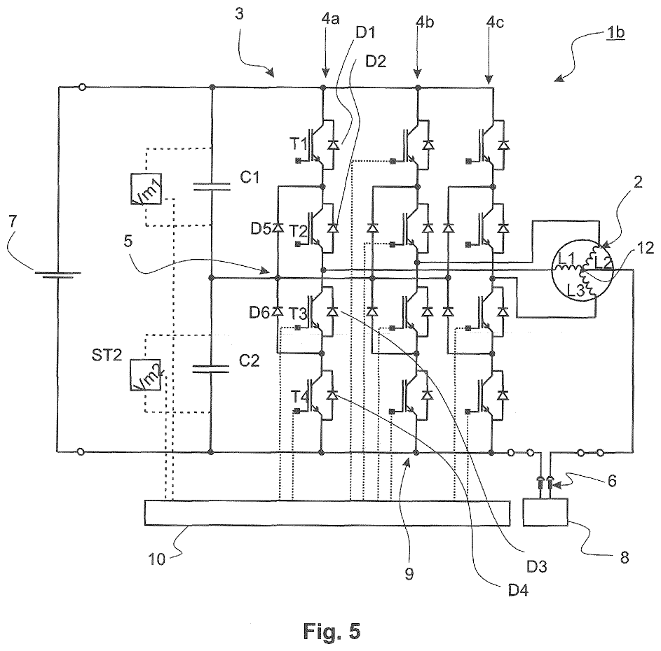

FIG. 5 shows another electric drive system 1b having a charging device according to the invention according to another preferred embodiment. Except for the transistors ST1 and ST2 of the switching device 9, the choke LD and the decoupling resistor RD from FIG. 1, the drive system 1b from FIG. 5 is identical to the drive system 1a from FIG. 1. In order to electrically charge and/or discharge the DC link center 5, the half bridge 4b is used as switching device 9 instead of additional transistors, e.g. ST1 and ST2 from FIG. 1. In this case, however, the half bridge 4b cannot be used as step-up converter during the charging mode. The control circuit 10 is adapted to control all four transistors T1 to T4 of half bridge 4b during the charging mode. To allow the electrical charge to flow from the DC link center 5 to the negative pole of battery 7, transistor T1 is opened and the remaining transistors T2 to T4 are closed. This circuit configuration allows current to flow via diode D5 and the transistors T2 to T4 of the half bridge 4b to the negative pole of battery 7. To conduct an electrical charge from the positive pole of battery 7 to the DC link center 5, transistor T4 is opened and transistors T1 to T3 are closed. This circuit configuration allows current to flow from the positive pole of battery 7 via transistors T1 to T3 and diode D6 of half bridge 4b.

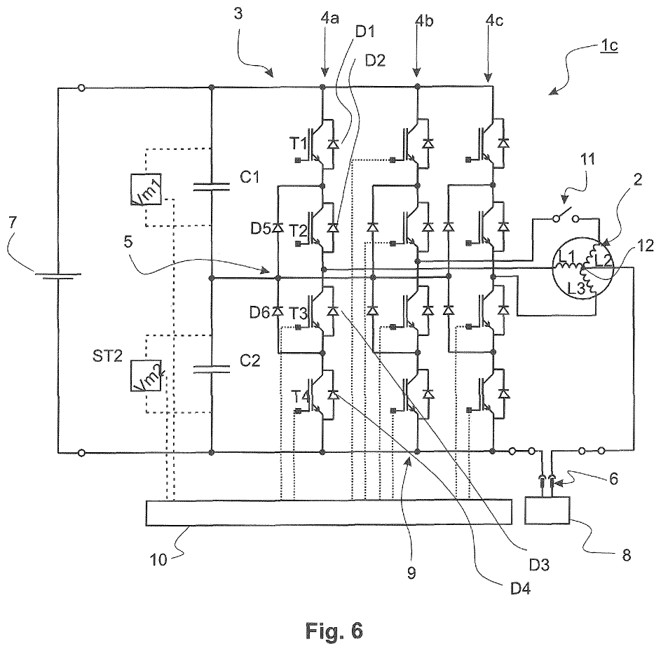

FIG. 6 shows another electric drive system 1c with an charging device according to the invention according to another preferred embodiment. With the exception of switch 11, the embodiment is identical to that shown in FIG. 5. In charging mode, the switch 11 disconnects the inverter 4b from the coil L2. In travel mode, the switch 11 is closed.

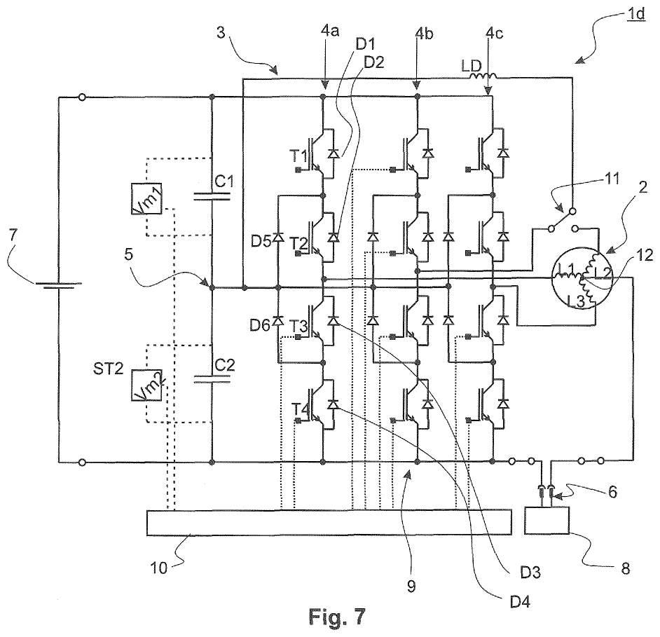

FIG. 7 shows another electric drive system 1d with a charging device according to the invention according to another preferred embodiment. Except for the use of the operating mode switch 11 and a choke coil LD that can be switched on via this switch, the drive system 1d from FIG. 7 is identical to the drive system 1b from FIG. 5. The half bridge 4b again serves as a controllable switching device 9 during the charging mode and as an inverter during the travel mode. The switch 11 connects the half bridge 4b with the coil L2 during the travel mode. In the charging mode, switch 11 connects half bridge 4b instead of coil L2 to choke LD and thus to the DC link center 5. By controlling the transistors T1 to T4 of half bridge 4b accordingly, a current can flow to the DC link center 5 (via T1I, T2, switch 11 and choke LD) or flow from center 5 (via choke LD, switch 11, T3 and T4).

The charging devices shown in FIGS. 5, 6 and 7 have the advantage that ideally no additional components need to be used; this is possible if the internal inductors and resistance of the half bridge is, relatively speaking, sufficiently high for the “neutral point currents” that occur. This is the case, for example, with low charging powers or with a very high clock frequency of the balancing leg or switching device 9. Since the electrical drive systems in FIGS. 5 and 6 use one of the half bridges as switching device for the DC link center during the charging mode, only two of the three legs of the inverter can work as step-up converters, which initially pushes the charging power to ⅔ of the maximum continuous power. By cyclically permuting the half bridge responsible for voltage balancing, this disadvantage can be partially compensated for by operating the step-up half bridges above their permanently fixed power limit for manageable or predetermined periods of time in order to acclimatize again in the subsequent voltage balancing mode. Depending on the side conditions, it may be necessary to separate the phases from the motor windings analogous to the embodiments 6 and 7. In this case, a plurality of switches 11 and, if necessary, charging impedance can be provided for each phase.

### LIST OF REFERENCE NUMERALS

1a electric drive system, first embodiment
1b electric drive system, second embodiment
1c electric drive system, third embodiment
1d electric drive system, fourth embodiment
2 electric motor/electric drive motor
3 inverters/drive inverters
4a first half bridge or inverter for the 1st phase
4b second half bridge or inverter for the 2nd phase
4c third half bridge or inverter for the 3rd phase
5 DC link center
6 plug connection
7 vehicle battery
8 charging source or charging station
9 switching device
10 control circuit
11 operating mode switch
12 star point
L1 first motor winding
L2 second motor winding
L3 third motor winding
C1 first capacitor
C2 second capacitor
T1 first transistor
T2 second transistor
T3 third transistor
T4 fourth transistor
D1 first recovery diode
D2 second recovery diode
D3 third recovery diode
D4 fourth recovery diode
D5 first intermediate diode
D6 second intermediate diode
LD choke Coil
RD decoupling resistor
ST1 charging transistor—first transistor of the switching device
ST2 discharge transistor—second transistor of the switching device
A1 PWM or rectangular signal generator
B1 first signal modulator
B2 second signal modulator
VM1 first voltmeter
VM2 second voltmeter

1. Charging device for charging a battery of a motor vehicle having with an electric drive motor, comprising
an inductor,
a drive converter, wherein in the drive mode of the motor vehicle, the drive converter converts a DC voltage of the battery for the electric drive motor and has an DC link center, wherein the inductor together with the drive converter serves as a step-up converter for a charging operation of the battery, and
a controllable switching device configured to charge and/or discharge the DC link center to a voltage.

2. Charging device according to claim 1,
wherein
the switching device is configured to connect the DC link center with the positive pole and/or with the negative pole of the battery.

3. Charging device according to claim 1,
wherein
the switching device has at least two transistors which are connected to the positive pole and the negative pole of the battery and are connected to the DC link center via a choke coil.

4. Charging device according to claim 1,
wherein
the inductor is formed by at least one winding of the electric drive motor.

5. Charging device according to claim 1,
wherein
the drive inverter for three voltage phases each comprises a 3-level inverter, each 3-level inverter is connected to one of the three windings of the electric drive motor.

6. Charging device according to claim 5,
wherein
the three 3-level inverters have the same DC link center.

7. Charging device according to claim 5,
wherein
one of the three 3-level inverters is the switching device.

8. Charging device according to claim 7,
wherein
the switching device is separably connected to a winding of the electric drive motor.

9. Charging device according to claim 1,
wherein
the DC link center is arranged between two capacitors connected in series, the battery being connectable in parallel with the capacitors.

10. Charging device according to claim 1,
further comprising
a control circuit for controlling the drive inverter, in particular its 3-level inverter or half bridges, as step-up converter and for controlling the switching device.

11. Charging device according to claim 10,
further comprising
a voltage measuring device for measuring the voltage of the DC link center, wherein the control circuit is configured to control the switching device as a function of the measured voltage.

12. Electric drive system with a charging device according to claim 1.

13. Charging device according to claim 2,
wherein
the switching device has at least two transistors which are connected to the positive pole and the negative pole of the battery and are connected to the DC link center via a choke coil.

14. Charging device according to claim 13,
wherein
the inductor is formed by at least one winding of the electric drive motor.

15. Charging device according to claim 14,
wherein
the drive inverter for three voltage phases each comprises a 3-level inverter, each 3-level inverter is connected to one of the three windings of the electric drive motor.

16. Charging device according to claim 15,
wherein
the three 3-level inverters have the same DC link center.

17. Charging device according to claim 16,
wherein
one of the three 3-level inverters is the switching device.

18. charging device according to claim 17,
wherein
the switching device is separably connected to a winding of the electric drive motor.

19. Charging device according to claim 18,
wherein
the DC link center is arranged between two capacitors connected in series, the battery being connectable in parallel with the capacitors.

20. Charging device according to claim 19,
further comprising
a control circuit for controlling the drive inverter, in particular its 3-level inverter or half bridges, as step-up converter and for controlling the switching device, and
a voltage measuring device for measuring the voltage of the DC link center, wherein the control circuit is configured to control the switching device as a function of the measured voltage.
